(19) United States
(12) Patent Application Publication
(10) Pub. No.: US 2005/0268800 A1
(43) Pub. Date: Dec. 8, 2005

(54) Locking bars for screen printing

(76) Inventor: Alan J. Hamu, Sunset Beach, CA (US)

Correspondence Address: Boniard I. Brown, 1500 West Covina parkway, #113, West Covina, CA, 91790-2793, US

(21) Appl. No.: 11/145,298

(22) Filed: Jun. 3, 2005

Related U.S. Application Data
(60) Provisional application No. 60/577,287, filed on Jun. 4, 2004.

(51) Int. Cl. B41L 13/00

(52) U.S. Cl. 101/127.1

(57) ABSTRACT

A locking bars assembly for screens of screen printing apparatus has locking bars at each opposite edge of a fabric member to be imprinted to receive edge strips of two respective types.

### RELATED APPLICATIONS

Reference is made to my Provisional Application No. 60/577,287, filed Jun. 4, 2004, entitled Locking Bars For Screen Printing.

### BACKGROUND AND SUMMARY OF THE INVENTION

The present invention relates to silk screen printing frames strips, typically formed of plastic, provided on silk screen fabric panels, typically with strips affixed to opposite edges of pre-cut pieces of fabric. U.S. Pat. No. 5,443,003 to Larson relates to such arrangement.

Silkscreening enables reproduction of a selected pattern at relatively low expense. Cut pieces of silk screen mesh are typically secured on opposite edges of a fabric screen by locking strips formed of plastic material.

It is desired in practice that silk screens of large size, typically rectangular, be adapted to be rolled up, particularly for shipping. The reason is that it is desired that there be no wrinkle or crease in the silk screen, so that when the screen arrives at a production plant or printing shop, it can be unrolled and installed in a screen printing frame utilizing the plastic strips provided on opposite edges of the silk screen fabric. The plastic strips are of such cross-sectional configuration that they fit in grooves in locking bars of silk screen printing assemblies.

### BRIEF DESCRIPTION OF THE DRAWINGS

FIG. 1 is an exploded perspective view of a silk screen frame and screen with edge strips attached;

FIG. 2 is a sectional view taken at line 2-2 in FIG. 1;

FIG. 3 is a sectional view taken at line 3-3 in FIG. 1, showing a bar according to the present invention;

FIG. 4 is a sectional view of a bar according to the present invention;

FIG. 5 is a sectional view of another bar according to the invention having therein a groove for a Shur-Loc™ type bar;

FIG. 6 is a sectional view of another bar according to the present invention;

FIG. 7 is a perspective view of a rolled-up screen with edge strips attached; and

FIG. 8 is a view similar to that of FIG. 2, showing utilization of locking grooves not particularly designed to receive Shur-Loc™ locking bars.

### DESCRIPTION OF PREFERRED EMBODIMENTS

The present invention relates to locking bars for screen printing assemblies, and particularly relative to a combination of two separate locking grooves defined in a bar or bars at each opposite end edges of a fabric screen, typically a silk screen.

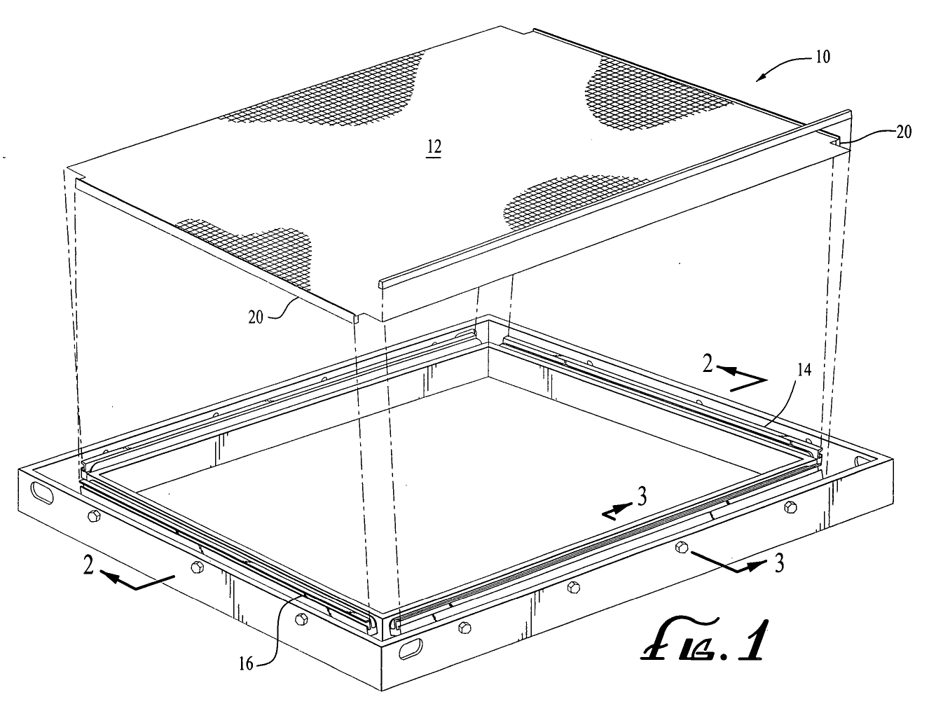

Referring to the drawings, FIG. 1 shows a screen printing apparatus 10 having thereon a silk screen panel 12. FIG. 2, which is a view taken at line 2-2 in FIG. 1, shows bars 14 and 16, each having defined therein a locking groove 18 adapted to receive a Shur-Loc™ plastic strip 20, such trademark being the property of James Larson, Snohomish, Wash. One of the grooves is thus adapted and configurated to receive plastic strips of the Shur-Loc™ type.

The plastic strips are secured on two opposite edges of a typically rectangular silk screen. A pre-cut silk screen panel has edges to engage in the locking grooves to receive the strips. The strips in the opposite edges of the screen panel enable the rolling-up of the panel, as for shipping.

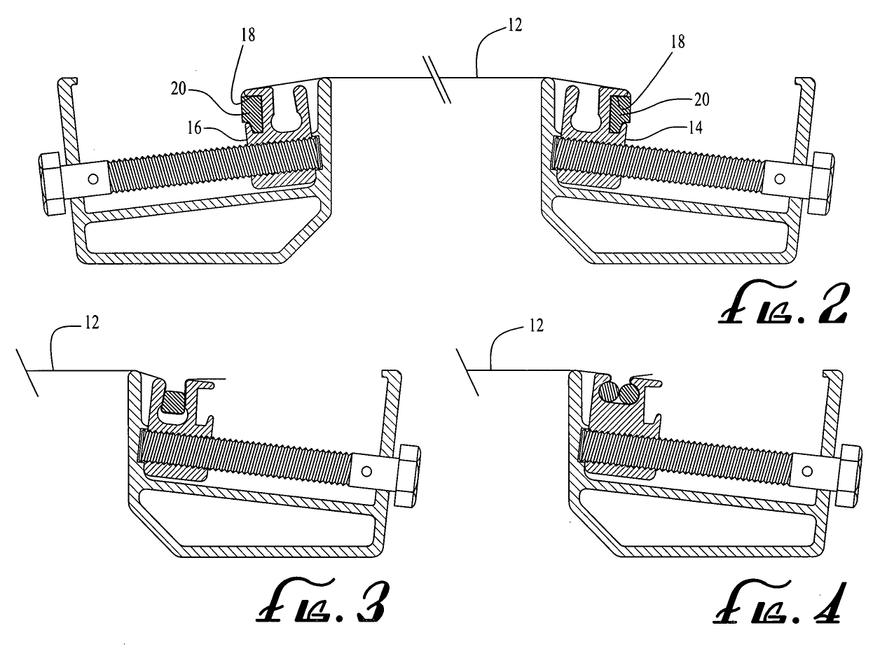

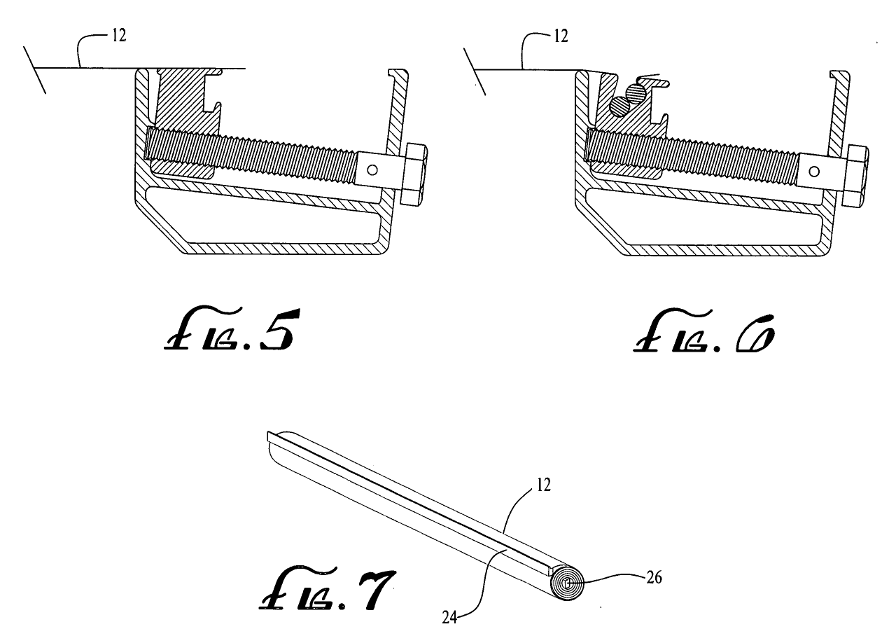

FIGS. 3 through 6 show respective bars, all of each having a groove adapted to receive the Shur-Loc™ locking strips, and having a second groove of respective configurations to receive conventional gripping rods or members.

Thus, according to the invention, two or dual grooves are provided in each bar, one groove receiving a conventional rod or member, and the other being adapted to receive a Shur-Loc™ locking strip configuration.

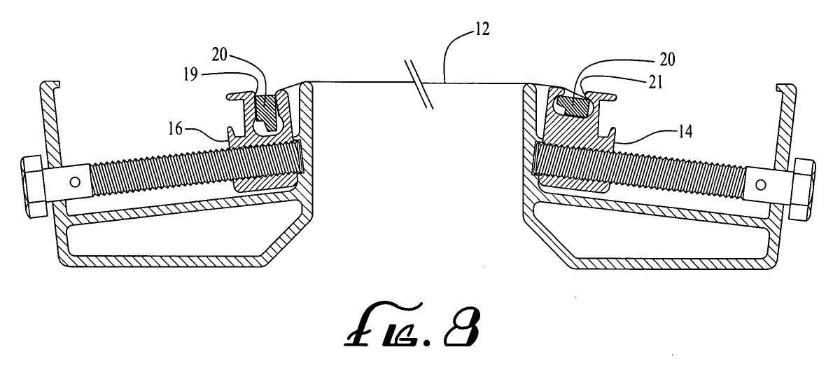

FIG. 7 shows a rolled-up silk screen with plastic strips member 24 disposed on its outer edge, and a second plastic strip 26 within the rolled-up silk screen. The rolled-up silk screen is thus adapted for shipment without wrinkling or creasing the silk screen.

It is possible, in some instances, to retain a Shur-Loc™ locking bar in a locking groove not specifically designed to receive it. FIG. 8 shows locking grooves 19 and 21 in which Shur-Loc™ locking bars are retained, although these grooves were not particularly designed to receive Shur-Loc™ locking bars.

Thus, depending upon the particular configuration, dimensions, manufacturing tolerances, etc. of the locking groove, a Shur-Loc™ locking bar may be adequately retained against the tension of a silk screen under load. However, probably in most instances, the Shur-Loc™ strip will not be properly retained in a groove not designed for the Shur-Loc™ strip.

1. A locking bars assembly for fabric screens of a screen printing apparatus, comprising:
a locking bar secured at each opposite end edge of a fabric member to be imprinted, and
the respective locking bars having therein two generally parallel locking grooves to receive respective edge strips, a first one of said grooves being configurated and adapted to receive edge strips of the ShurLoc™ type, and the second of said grooves being configurated and adapted to receive onr or more conventional types of locking bars.

2. A locking bars assembly according to claim 1 wherein the fabric screen is a silkscreen.

3. A locking bars assembly according to claim 1 wherein said locking bars are formed of plastic material.

4. A locking bars assembly according to claim 1 wherein two gripping devices and locking grooves are provided on a screen printing frame.

5. A locking bars assembly for fabric screens of a screen printing apparatus, comprising:
a screen printing frame having movable locking bars and more than one gripping device and locking groove, and
locking grooves for silk screen mesh,
whereby a plurality of at least two locking grooves and gripping devices eliminate switching from one locking bar and groove to another, as required in the prior art which requires locking bar assemblies to be removed and replaced by tensioning bars of different gripping configurations, requiring substantial time and labor.

6. A locking bars assembly according to claim 5 wherein two different locking grooves are defined in a single bar at each opposite edge of said silk screen mesh.

7. A locking bars assembly according to claim 5 wherein said locking bars are formed of a plastic material.

8. A locking bars assembly according to claim 5 wherein said edge strips are formed of plastic material.

9. A locking bars assembly according to claim 5 wherein the time and cost of switching from one gripping device to another is substantially eliminated.

10. A locking bars assembly for fabric screens of a screen printing apparatus, comprising:
a locking bar secured at each of opposite end edges of a fabric member to be imprinted, and
respective locking bars each having two separate grooves therein of different respective cross-sectional configurations, whereby changing and reversing respective locking bars and grooves of respective cross-sections requires no disassembly and reassembly of a silk screen frame with attendant substantial reduction in labor and expense.

11. A locking bars assembly according to claim 10 wherein two different locking grooves are defined in a single bar disposed at each opposite edge of said silk screen.

12. A locking bars assembly according to claim 10 wherein the fabric screens have locking bars mounted thereon.

13. A locking bars assembly according to claim 10 wherein the fabric screen is a silkscreen.

14. A locking bars assembly according to claim 10 wherein two gripping devices and locking grooves are provided on a screen printing frame.

15. A locking bars assembly according to claim 10 wherein said locking bars are formed of a plastic material.

16. A locking bars assembly according to claim 10 wherein said edge strips are-formed of plastic material.

17. A locking bars assembly according to claim 10 wherein the time and cost of switching from one gripping device to another is substantially eliminated.
